(19) United States
(12) Patent Application Publication
(10) Pub. No.: US 2026/0158764 A1
(43) Pub. Date: Jun. 11, 2026

(54) Moisture-Resistant Laminated Film Assembly with Enhanced Adhesion for Glass Surfaces

(71) Applicant: Jay Allan Winick, Montreal (CA)

(72) Inventor: Jay Allan Winick, Montreal (CA)

(21) Appl. No.: 18/973,188

(22) Filed: Dec. 9, 2024

(51) Int. Cl. B32B 7/12; B32B 23/08; B32B 33/00

(52) U.S. Cl. CPC B32B 7/12; B32B 23/08; B32B 33/00; B32B 2307/42; B32B 2307/7265; B32B 2317/18; B32B 2457/208

(57) ABSTRACT

A laminated film assembly for application to glass surfaces is disclosed. The assembly comprises a cellulose triacetate (CTA) layer configured to polarize light, a moisture-inhibiting layer formed from a non-porous plastic material to block moisture ingress, a first adhesive layer bonding the CTA layer to the moisture-inhibiting layer, and a second adhesive layer disposed on the side of the moisture-inhibiting layer opposite the CTA layer. The second adhesive layer is configured to adhere the assembly to a glass surface or other substrate. The invention prevents moisture-related degradation of the CTA layer, ensuring reliable installation and long-term performance in applications requiring privacy and light-polarizing functionality.

### FIELD OF INVENTION

The present invention relates generally to the field of laminated film assemblies for application to glass surfaces. More specifically, it pertains to a moisture-resistant film assembly incorporating a cellulose triacetate (CTA) layer and a moisture-inhibiting layer.

### BACKGROUND

The challenges inherent in the application and installation of polarizing films on glass surfaces have long been a source of inefficiency and frustration for both professional installers and end users. In the domain of window films, particularly those utilizing cellulose triacetate (CTA) layers for light polarization and display obscuration, existing solutions have demonstrated limitations that significantly hinder their practicality and versatility. These issues are most pronounced during the installation process, where the interaction between film materials and moisture poses unique complications.

Historically, the use of CTA films has necessitated careful management of moisture exposure. CTA, while advantageous for its light-polarizing properties, is highly susceptible to moisture absorption. This characteristic compromises the shape of the material. When exposed to water or water-based solutions during application, the CTA layer often absorbs moisture, resulting in curling, warping, or adhesion failures. These issues have rendered the installation of such films labor-intensive, error-prone, and dependent on specialized techniques to mitigate moisture-related damage.

Some existing approaches, such as those based on Polyethylene Terephthalate (PET), have sought to address some of these challenges by performing dry installations. However, while PET-based adhesives do enable dry application, the process is often impractical due to the adhesive's inherent properties, which make positioning and adjustment of the film on glass surfaces exceedingly difficult. This difficulty is compounded by the adhesive's strong initial tack, which restricts repositioning and increases the likelihood of errors during installation.

It is within this context that the present invention is provided.

### SUMMARY

The present invention provides a laminated film assembly configured for application to glass surfaces. The assembly includes a cellulose triacetate (CTA) layer designed to polarize light, thereby providing privacy or obscuration of display contents when applied. The invention incorporates a moisture-inhibiting layer disposed adjacent to the CTA layer, formed from a non-porous plastic material that prevents moisture ingress into the CTA layer. This feature simplifies installation, as it mitigates the common issues associated with moisture absorption, such as curling or adhesion failures. The assembly further comprises a first adhesive layer bonding the CTA layer to the moisture-inhibiting layer and a second adhesive layer for adhering the film assembly to a glass surface or other supporting substrate.

The inclusion of the moisture-inhibiting layer and the layered adhesive system allows the assembly to achieve effective adhesion and durability, maintaining the shape of the CTA layer during installation. The invention is particularly suited for applications requiring ease of installation, reusability, and resistance to environmental factors such as moisture, while maintaining the functional benefits of polarized light transmission and display privacy.

In some embodiments, the second adhesive layer is a physical adhesion layer which adheres to the glass surface through mechanical adhesion and intermolecular forces, avoiding the use of chemical adhesives. This feature facilitates clean removal and repositioning of the assembly without leaving residue on the glass.

In further embodiments, the physical adhesion layer comprises materials such as polyethylene terephthalate (PET), polyvinyl chloride (PVC), silicone, or thermoplastic polyurethane (TPU). These materials provide enhanced adhesion and compatibility with a variety of glass surfaces while maintaining flexibility and durability.

In yet further embodiments, the moisture-inhibiting layer comprises a material selected from polycarbonate (PC), acrylic (PMMA), polystyrene (PS), polyethylene (PE), polypropylene (PP), thermoplastic polyurethane (TPU), nylon, or polymethylpentene (PMP). The use of these materials enhances the moisture resistance of the assembly, ensuring long-term performance and stability.

In some embodiments, the first adhesive layer bonding the CTA layer to the moisture-inhibiting layer comprises adhesives such as cyanoacrylate, epoxy, polyurethane, or solvent-based adhesives. These adhesives ensure a secure bond between the layers, maintaining the integrity of the assembly under varying environmental conditions.

In further embodiments, the second adhesive layer comprises an acrylic adhesive or other adhesives suitable for bonding the moisture-inhibiting layer to the glass surface or physical adhesion layer. These adhesives provide strong and reliable adhesion while allowing flexibility in the choice of substrates.

In yet further embodiments, the physical adhesion layer includes surface modifications such as texturing to enhance mechanical adhesion and intermolecular forces. This increases the strength of adhesion and reduces the likelihood of detachment during use.

In some embodiments, the physical adhesion layer includes micro-suction structures configured to facilitate vacuum sealing to the glass surface. This feature enhances the repositionability of the film assembly, allowing for multiple installations without compromising adhesion.

In further embodiments, the moisture-inhibiting layer is optimized in thickness to balance flexibility and rigidity, enabling easy application while maintaining structural integrity during use.

In yet further embodiments, the CTA layer is treated to enhance its light-polarizing efficiency, improving the assembly's ability to obscure display contents and provide privacy when applied to glass surfaces.

In some embodiments, the assembly includes a protective liner over the second adhesive layer to protect the adhesive prior to application. This ensures the adhesive's integrity during storage and handling.

In further embodiments, the assembly is configured to allow for the transmission of touchscreen signals through the CTA layer and the moisture-inhibiting layer, enabling its use on interactive displays without interference.

In yet further embodiments, the assembly includes an ultraviolet (UV) protection layer integrated into or applied to the CTA layer. This provides UV filtering properties, protecting underlying surfaces or displays from UV exposure.

### BRIEF DESCRIPTION OF THE DRAWINGS

Various embodiments of the invention are disclosed in the following detailed description and accompanying drawings.

FIG. 1 illustrates an example laminated film assembly with all layers shown, including protective liners.

FIG. 2 illustrates an example laminated film assembly with the protective liners removed, showing the film adhered to a glass substrate and light polarization.

FIG. 3 illustrates an example application of the laminated film assembly on an LED screen, demonstrating the polarizing effect and obscuration of display contents.

FIG. 4 illustrates an example process flow diagram showing the installation steps for the laminated film assembly.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

When a feature or element is described as being “on” or “directly on” another feature or element, there may or may not be intervening features or elements present. Similarly, when a feature or element is described as being “connected,” “attached,” or “coupled” to another feature or element, there may or may not be intervening features or elements present. The features and elements described with respect to one embodiment can be applied to other embodiments.

The use of spatial terms, such as “under,” “below,” “lower,” “over,” “upper,” etc., is used for ease of explanation to describe the relationship between elements when the apparatus is in its proper orientation.

The terms “first,” “second,” and the like are used to distinguish different elements or features, but these elements or features should not be limited by these terms. A first element or feature described can be referred to as a second element or feature and vice versa without departing from the teachings of the present disclosure.

The term “cellulose triacetate (CTA) layer” refers to a film layer capable of polarizing light. This includes, but is not limited to, cellulose triacetate or any other material with light-polarizing properties, such as cellulose derivatives or light-polarizing polymers known to those skilled in the art. In one example implementation, the CTA layer may be a cellulose triacetate film with a thickness of approximately 100 micrometers, treated to enhance its light-polarizing efficiency for display obscuration and privacy applications.

The term “moisture-inhibiting layer” refers to a non-porous plastic material disposed adjacent to the CTA layer, designed to prevent moisture ingress that could degrade the properties of the CTA layer. This layer may include, but is not limited to, materials such as polycarbonate (PC), acrylic (PMMA), polyethylene terephthalate (PET), or thermoplastic polyurethane (TPU). In one example implementation, the moisture-inhibiting layer may be a polycarbonate film with a thickness optimized to balance flexibility for installation and rigidity to maintain structural stability.

The term “adhesive layer” refers to an adhesive material that bonds two layers together. The adhesive layers may include, but are not limited to, cyanoacrylate adhesives, polyurethane adhesives, two-part epoxies, or solvent-based adhesives. In one example implementation, the first adhesive layer may be a cyanoacrylate adhesive applied as a thin coating to ensure strong bonding while maintaining optical clarity. The second adhesive layer may include acrylic-based adhesives or any other adhesives suitable for bonding to glass or non-porous substrates.

In one example implementation, the second adhesive layer may be a pressure-sensitive acrylic adhesive with a thickness of 50 micrometers, optimized for clean removal and reusability.

In another example implementation, the second adhesive layer is a “physical adhesion layer” configured to secure the laminated film assembly through mechanical adhesion and intermolecular forces. This layer may include materials such as polyethylene terephthalate (PET), silicone, polyvinyl chloride (PVC), or thermoplastic polyurethane (TPU). In one example implementation, the physical adhesion layer may be a PET film with micro-suction structures or surface texturing to enhance adhesion to glass without the use of chemical adhesives.

The term “protective liner” refers to a removable layer designed to shield the adhesive layers during storage and handling. This includes, but is not limited to, polyester films, polyethylene films, or any other non-stick materials commonly used in adhesive-backed laminates. In one example implementation, the protective liner may be a silicone-coated polyethylene terephthalate (PET) film designed for easy peeling without damaging the underlying adhesive.

The term “UV protection layer” refers to a layer integrated into or applied to the CTA layer to provide ultraviolet (UV) filtering properties. This includes, but is not limited to, UV-blocking films or coatings applied during manufacturing or post-processing. In one example implementation, the UV protection layer may be a clear, thin film of UV-absorbing material, such as a benzotriazole-based compound, bonded to the CTA layer to protect underlying surfaces or displays from UV degradation.

### DESCRIPTION OF DRAWINGS

The present invention relates to a laminated film assembly designed for application to glass surfaces, offering improvements over existing solutions in the field of privacy and display security films. The invention addresses the challenges associated with the installation and performance of films utilizing cellulose triacetate (CTA) layers, particularly those resulting from moisture absorption, installation complexity, and the limitations of existing adhesive systems.

Conventional polarizing films are often prone to performance degradation due to the susceptibility of the CTA layer to moisture ingress. This characteristic complicates the installation process, particularly in wet application methods, and can lead to defects such as curling or adhesion failures.

The invention overcomes these shortcomings by integrating a moisture-inhibiting layer between the CTA layer and the adhesive. This non-porous plastic layer acts as a robust barrier, effectively blocking moisture from reaching the CTA layer during and after installation. The moisture-inhibiting layer enables the use of wet application methods, which simplify positioning and adjustment of the film while avoiding the moisture-related issues prevalent in prior systems. Additionally, the layered design ensures strong and reliable adhesion to glass surfaces or other substrates, preserving the film's structural integrity and optical clarity.

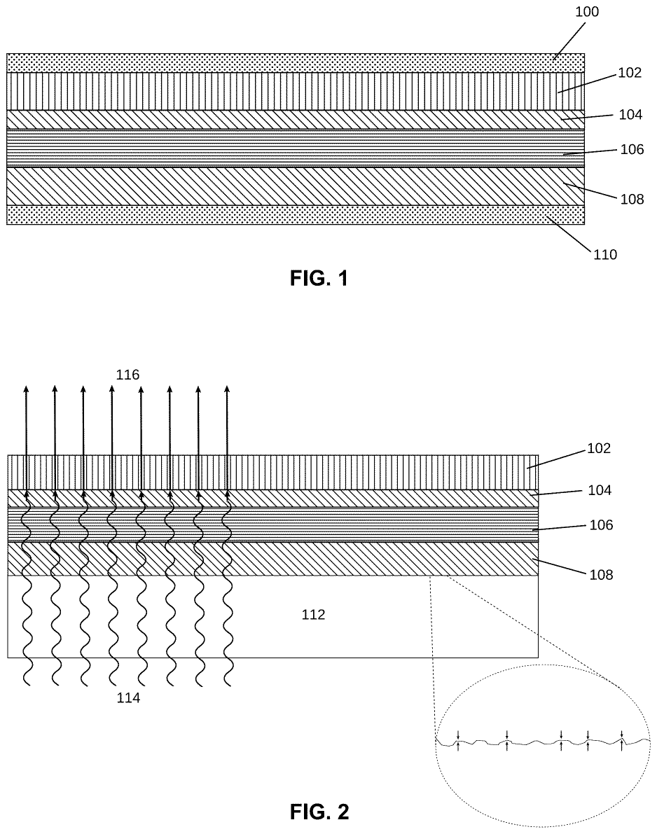

Referring now to the drawings, FIG. 1 illustrates a laminated film assembly designed for application to glass surfaces, showing a layered structure that addresses common challenges such as moisture ingress, installation complexity, and durability.

The assembly begins with a removable protective liner 100. This layer serves to shield the adhesive beneath it during storage and handling, ensuring that the adhesive remains clean and effective until the film assembly is ready for installation. The protective liner 100 is removed immediately before application to expose the adhesive surface.

Directly beneath the protective liner 100 is the cellulose triacetate (CTA) layer 102, a light-polarizing film that provides privacy and display obscuration. The CTA layer 102 is treated to enhance its light-polarizing efficiency, ensuring that light passing through the assembly is filtered or polarized, making it particularly useful in applications requiring privacy or display security.

An adhesive layer 104 securely attaches the CTA layer 102 to the underlying structure while maintaining optical clarity and structural stability. Suitable adhesives for this layer include cyanoacrylate, polyurethane, or epoxy, chosen for their strong bonding capabilities and compatibility with both the CTA layer 102 and the moisture-inhibiting layer 106.

A moisture-inhibiting layer 106 is located beneath the adhesive layer 104. This layer is formed from a non-porous plastic material designed to block moisture from reaching the CTA layer 102. The moisture-inhibiting layer 106 significantly enhances the durability of the assembly by preventing issues such as curling, warping, or adhesion failures caused by moisture ingress. Its thickness is optimized to balance flexibility for ease of application and rigidity to ensure structural integrity.

A range of moisture-inhibiting substrates can be utilized in the laminated film assembly, each offering distinct properties and compatibility with specific adhesives. Acrylic (PMMA), known as Plexiglass or Lucite, is a versatile material that bonds well with cyanoacrylate, epoxy, and solvent-based adhesives. Polycarbonate (PC) is highly durable and impact-resistant, compatible with cyanoacrylate, epoxy, and polyurethane adhesives, though it may require surface cleaning or priming for optimal bonding. Polyethylene terephthalate (PET or PETG), commonly found in packaging materials, adheres effectively to polyurethane and silicone-based glues, with surface treatments such as flame or plasma processes further improving adhesion. Polystyrene (PS), used in model-making and packaging, works well with specialized plastic adhesives. PVC (polyvinyl chloride) bonds effectively with solvent-based or PVC-specific adhesives, while polypropylene (PP) and polyethylene (PE) require specialty adhesives designed for low-energy surfaces or surface treatments to improve bonding. Thermoplastic polyurethane (TPU) is flexible and suitable for use with hot-melt adhesives, polyurethane adhesives, and epoxies. Other options include cellulose acetate, which bonds with cyanoacrylate and epoxy adhesives, and nylon (polyamide), which adheres effectively with epoxy or polyurethane adhesives. Polymethylpentene (PMP) is a lightweight, clear material that bonds with agents designed for polyolefins, offering additional options for moisture-resistant film designs.

Beneath the moisture-inhibiting layer 106 is an adhesive or physical adhesion layer 108, which serves to bond the entire film assembly to the glass surface or another supporting substrate. This layer is versatile and can take one of two forms.

In one implementation, it acts as a physical adhesion layer composed of materials such as polyethylene terephthalate (PET), silicone, or polyvinyl chloride (PVC). When implemented as a physical adhesion layer, it adheres to the glass surface through mechanical adhesion and intermolecular forces, enabling repositioning and residue-free removal.

Alternatively, in another implementation, this layer may function as a conventional adhesive layer, such as a pressure-sensitive acrylic adhesive, designed for direct bonding to the glass surface. The material choice for this layer depends on the intended application and specific user requirements.

The assembly is completed with a second removable protective liner 110, located beneath the adhesive or physical adhesion layer 108. This protective liner 110 shields the adhesive layer during storage and handling, ensuring its integrity until the film assembly is ready for application. All of the layers besides the protective liners should be at least partially transparent.

FIG. 2 illustrates a laminated film assembly in a configuration where the protective liners have been removed, showing the layers in direct interaction with a glass substrate 112 and unpolarized light being emitted through it. This depiction highlights the assembly during or after installation, demonstrating its ability to adhere securely to the glass substrate 112 and its functional performance in polarizing light.

The bottommost layer of the assembly, as shown, is the second adhesive layer 108, implemented as a polyethylene terephthalate (PET) layer in this example. The PET layer 108 functions as a physical adhesion layer, mechanically bonded to the surface of the glass substrate 112 through intermolecular forces and mechanical adhesion between the two imperfect surfaces and vacuum pressures formed therebetween, as shown in the zoomed in section. This configuration ensures secure attachment while allowing for clean removal and potential repositioning, a feature enabled by the properties of PET.

Above the PET layer 108 lies the moisture-inhibiting layer 106, composed of a non-porous plastic material such as polycarbonate (PC), acrylic (PMMA), or thermoplastic polyurethane (TPU). The moisture-inhibiting layer 106 blocks the ingress of moisture, preventing damage or degradation to the overlying layers, particularly the cellulose triacetate (CTA) layer 102. This design ensures the long-term durability and stability of the film assembly even in environments where moisture exposure is prevalent.

The adhesive layer bonding the moisture-inhibiting layer to the CTA layer 104 ensures a secure connection between these two components while maintaining the optical clarity necessary for light polarization. This adhesive layer 104, which may include materials such as cyanoacrylate, polyurethane, or epoxy, is specifically chosen for its compatibility with both the moisture-inhibiting layer 106 and the CTA layer 102.

The CTA layer 102 is shown at the top of the assembly and functions as the active light-polarizing component. As unpolarized light 114 enters the assembly from the glass substrate 112, it passes through the PET layer 108, the moisture-inhibiting layer 106, and the adhesive layer 104 without significant alteration. However, upon reaching and passing through the CTA layer 102, the light becomes polarized 116. This process filters the light to allow only specific orientations of light waves to pass through, providing privacy, glare reduction, or other desired optical effects depending on the application.

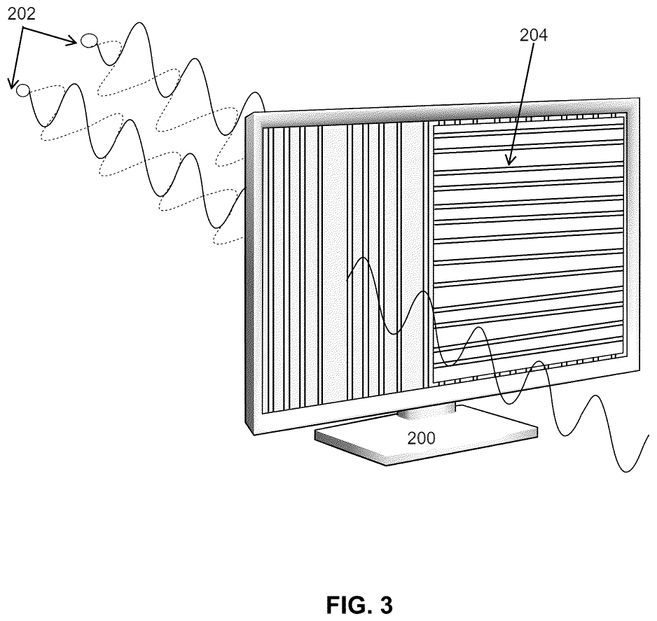

FIG. 3 illustrates a perspective view of an LED screen 200 with a portion of the laminated film assembly applied, demonstrating the assembly's ability to polarize light and obscure display contents. The assembly, as shown, adheres to the surface of the LED screen 200 and functions to control the transmission of light emitted from the screen, providing enhanced privacy or display security.

The laminated film assembly is positioned on the LED screen 200 with the second adhesive layer 108, implemented as a PET physical adhesion layer in this example, in direct contact with the screen surface. This PET layer mechanically adheres to the screen surface without the use of chemical adhesives, ensuring secure attachment while allowing for clean removal or repositioning. Above the PET layer is the moisture-inhibiting layer, which prevents moisture from reaching the upper layers of the assembly. This layer, composed of a non-porous plastic material such as polycarbonate (PC) or acrylic (PMMA), preserves the performance of the assembly by protecting the overlying layers from environmental damage.

Light emitted from the LED screen 200 passes through the laminated film assembly. Unpolarized light 202 from the screen enters the assembly, passing sequentially through the PET layer, the moisture-inhibiting layer, and the adhesive layer without significant alteration. Upon reaching the CTA layer 102, the light is polarized, allowing only specific orientations of light waves to pass through. This polarization is shown in the figure, with the resulting polarized light 204 depicted as filtered and selectively transmitted. This polarizing effect obscures display content from unintended viewing angles, providing privacy and security for the display.

The portion of the LED screen 200 covered by the laminated film assembly appears darker or blacked out when viewed from angles outside the polarization axis of the CTA layer.

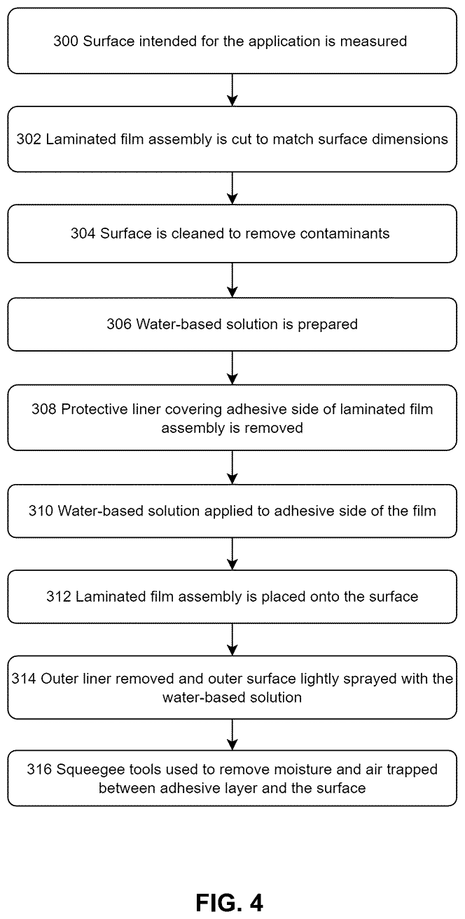

FIG. 4 illustrates a process flow diagram detailing the steps for installing the laminated film assembly, incorporating a moisture-inhibiting layer and adhesive layers.

In a first step 300, the glass surface intended for the application is measured to determine the required dimensions of the film assembly. This step ensures that the film will fit precisely onto the glass surface, avoiding any overhangs or gaps that could compromise functionality or aesthetics. In a second step 302, the laminated film assembly is cut to match the dimensions determined in the previous step.

In a third step 304, the glass surface is cleaned to remove contaminants such as dust, dirt, or grease. Proper cleaning is necessary to achieve clean adhesion between the glass and the film. This step may involve using alcohol-based solutions or other appropriate cleaning agents to prepare the surface for installation.

In a fourth step 306, a water-based solution is prepared to facilitate installation. This solution may contain a slip agent, such as dish soap or baby shampoo, which reduces the adhesive's immediate tackiness, allowing for fine adjustments to the film's position. When the adhesive used in the film assembly is PET-based, only water is used in the solution, as soap-based additives can interfere with adhesion.

In a fifth step 308, the protective liner covering the adhesive side of the laminated film assembly is removed. This exposes the adhesive layer, making it ready for application to the glass surface. In a sixth step 310, the water-based solution is applied to the adhesive side of the film, for example using a sprayer. This step temporarily neutralizes the adhesive's stickiness, enabling easier handling and alignment of the film during application.

In a seventh step 312, the laminated film assembly is placed onto the glass surface. The installer aligns the film with the edges of the glass, using the water-based solution to allow for precise positioning before the adhesive bonds with the surface.

In an eighth step 314, the outer protective liner is removed and the surface of the laminated film assembly is lightly sprayed with the water-based solution. This layer of solution facilitates the smooth movement of squeegee tools across the surface, preventing scratching or dragging during the removal of trapped moisture.

In a ninth step 316, squeegee tools are used to remove moisture and air trapped between the adhesive layer and the glass surface. This ensures that the film bonds securely to the glass, eliminating bubbles and residual water for a clean, professional finish.

### CONCLUSION

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the laminated film assembly of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A laminated film assembly for application to a glass surface, comprising:
a cellulose triacetate (CTA) layer configured to polarize light passing through the glass surface when the laminated film assembly is applied thereto;
a moisture-inhibiting layer disposed on a side of the CTA layer, wherein the moisture-inhibiting layer is formed from a non-porous plastic material configured to block the ingress of moisture into the CTA layer;
a first adhesive layer disposed between the CTA layer and the moisture-inhibiting layer, wherein the first adhesive layer is configured to bond the CTA layer to the moisture-inhibiting layer; and
a second adhesive layer disposed on a side of the moisture-inhibiting layer opposite the CTA layer, wherein the second adhesive layer is configured to adhere the moisture-inhibiting layer to a glass surface or another supporting substrate.

2. The laminated film assembly of claim 1, wherein the second adhesive layer is a physical adhesion layer, and wherein the physical adhesion layer is configured to adhere to the glass surface through mechanical adhesion and intermolecular forces without the use of chemical adhesives.

3. The laminated film assembly of claim 2, wherein the physical adhesion layer comprises a material selected from the group consisting of polyethylene terephthalate (PET), polyvinyl chloride (PVC), silicone, and thermoplastic polyurethane (TPU).

4. The laminated film assembly of claim 1, wherein the moisture-inhibiting layer comprises a material selected from the group consisting of polycarbonate (PC), acrylic (PMMA), polystyrene (PS), polyethylene (PE), polypropylene (PP), thermoplastic polyurethane (TPU), nylon, and polymethylpentene (PMP).

5. The laminated film assembly of claim 1, wherein the first adhesive layer comprises an adhesive selected from the group consisting of cyanoacrylate, epoxy, polyurethane, and solvent-based adhesives.

6. The laminated film assembly of claim 1, wherein the second adhesive layer comprises an acrylic adhesive or another adhesive suitable for bonding the moisture-inhibiting layer to the physical adhesion layer or directly to the glass surface.

7. The laminated film assembly of claim 1, wherein the physical adhesion layer includes surface modifications such as texturing to enhance mechanical adhesion and intermolecular forces.

8. The laminated film assembly of claim 1, wherein the physical adhesion layer includes micro-suction structures configured to facilitate vacuum sealing to the glass surface.

9. The laminated film assembly of claim 1, wherein the moisture-inhibiting layer is characterized by a thickness optimized to balance flexibility for ease of application and rigidity to maintain structural integrity during use.

10. The laminated film assembly of claim 1, wherein the CTA layer is treated to enhance its light-polarizing efficiency, thereby improving the obscuration of display contents when applied to the glass surface.

11. The laminated film assembly of claim 1, further comprising a protective liner disposed over the second adhesive layer to protect the adhesive prior to application.

12. The laminated film assembly of claim 1, wherein the assembly is configured to allow for the transmission of touchscreen signals through the CTA layer and the moisture-inhibiting layer, enabling interaction with touchscreen displays covered by the laminated film assembly.

13. The laminated film assembly of claim 1, further comprising an ultraviolet (UV) protection layer integrated into or applied to the CTA layer, configured to provide UV filtering properties when the film assembly is applied to the glass surface.
